(19) United States
(12) Patent Application Publication
(10) Pub. No.: US 2014/0197703 A1
(43) Pub. Date: Jul. 17, 2014

(54) ELECTRIC MOTOR ROTOR THERMAL INTERFACE FOR HUB/SHAFT

(71) Applicant: REMY TECHNOLOGIES, LLC, Pendleton, IN (US)

(72) Inventor: Bradley D. Chamberlin, Pendleton, IN (US)

(73) Assignee: REMY TECHNOLOGIES, LLC, Pendleton, IN (US)

(21) Appl. No.: 13/744,229

(22) Filed: Jan. 17, 2013

(51) Int. Cl. H02K 9/22

(52) U.S. Cl. CPC H02K 9/22
USPC 310/64

(57) ABSTRACT

A cooling system of an electric machine includes a hub, a rotor core, and a thermal interfacial material interposed between respective complementary mating surfaces of the hub and the rotor core for substantially eliminating air gaps therebetween. A method of cooling an electric machine having a rotor core and a hub includes placing a thermal interfacial material onto a heat transfer interface between the rotor core and the hub, whereby the thermal interfacial material reduces contact resistance at the heat transfer interface. A method includes providing a rotor core having a radially inner surface, coating at least one of a radially outer surface of a hub and the radially inner surface of the rotor core with a thermal interfacial material, and inserting the hub into the rotor core, whereby the thermal interfacial material is interposed between the inner surface of the rotor core and the outer surface of the hub.

### CROSS-REFERENCE

This application is filed on the same day as co-pending U.S. patent applications Ser. No. ______, entitled “ELECTRIC MOTOR STATOR HOUSING INTERFERENCE GAP REDUCING METHOD AND APPARATUS,” and Ser. No. ______, entitled “ELECTRIC MOTOR ROTOR THERMAL INTERFACE WITH AXIAL HEAT SINKS.” The subject matter of these two applications is incorporated herein in its entirety.

### BACKGROUND

The present invention is directed to improving the performance and thermal efficiency of electric machines and, more particularly, to methods and apparatus for improving the heat transfer process.

An electric machine is generally structured for operation as a motor and/or a generator, and may have electrical windings and/or permanent magnets, for example in a rotor and/or in a stator. Heat is produced in the windings and magnets, and by bearings or other sources of friction. Eddy currents and core losses occur within a rotor of an electric machine. Such losses result in undesirable heat within the rotor assembly. In a densely packed electric machine operating at a high performance level, excessive heat may be generated. Such heat must be removed to prevent it from reaching impermissible levels that may cause damage and/or reduction in performance or life of the motor.

Various apparatus and methods are known for removing heat. One exemplary method includes providing the electric machine with a water jacket having fluid passages through which a cooling liquid, such as water, may be circulated to remove heat. Another exemplary method may include providing an air flow, which may be assisted with a fan, through or across the electric machine to promote cooling. A further exemplary method may include spraying or otherwise directing oil or other coolant directly onto end turns of a stator winding.

There is generally an ongoing need for increasing performance and efficiency of electric machines, such by providing more power in a smaller space. Although various structures and methods have been employed for cooling an electric machine, improvement remains desirable.

### SUMMARY

It is therefore desirable to obviate the above-mentioned disadvantages by providing methods and apparatus for minimizing thermal resistance and increasing thermal efficiency.

According to an exemplary embodiment, a cooling system of an electric machine includes a hub member, a rotor core, and a thermal interfacial material interposed between respective complementary mating surfaces of the hub member and the rotor core for substantially eliminating air gaps therebetween.

According to another exemplary embodiment, a method of cooling an electric machine having a rotor core and a hub member includes placing a thermal interfacial material onto a heat transfer interface between the rotor core and the hub member, whereby the thermal interfacial material reduces contact resistance at the heat transfer interface.

According to a further exemplary embodiment, a method of cooling a stator of an electric machine includes providing a rotor core having a radially inner surface, coating at least one of a radially outer surface of a hub member and the radially inner surface of the rotor core with a thermal interfacial material, and inserting the hub member into the rotor core, whereby the thermal interfacial material is interposed between the inner surface of the rotor core and the outer surface of the hub member.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an electric machine;

FIGS. 2A and 2B are schematic views showing heat transfer across the interface of two abutting surfaces;

FIG. 3 is an exploded perspective view of a rotor assembly, according to an exemplary embodiment;

FIG. 4 is a perspective view of an exemplary rotor core formed as a stack of steel laminations;

FIG. 5 is a partially exploded view of the rotor assembly of FIG. 3;

FIG. 6 is a cross-sectional schematic view of a rotor assembly after application of thermal interfacial material to the interface between a hub and a rotor core, according to an exemplary embodiment;

FIG. 7 is an elevation view of an exemplary TIM applicator; and

FIG. 8 is a top view of the applicator of FIG. 7.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

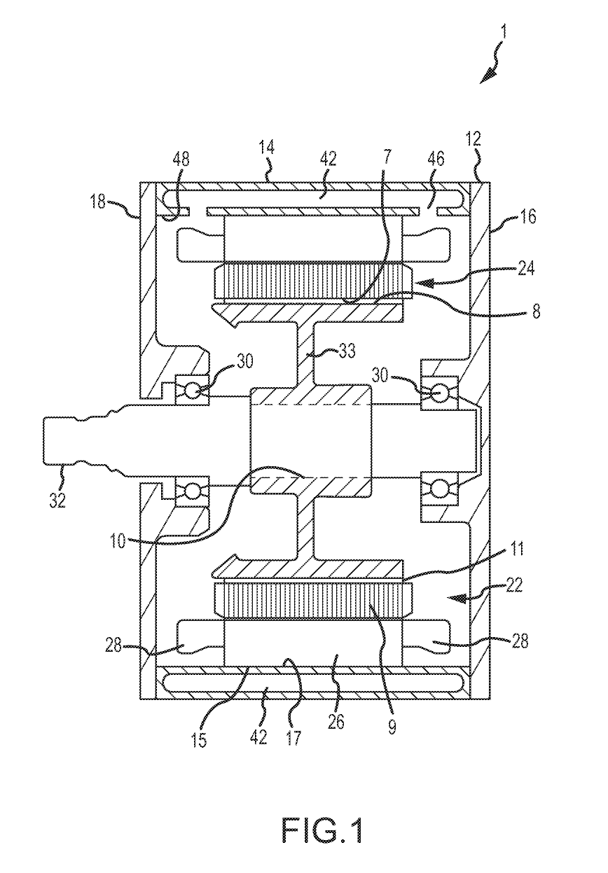

FIG. 1 is a schematic cross-sectional view of an exemplary electric machine assembly 1. Electric machine assembly 1 may include a housing 12 that has a body 14, a first end cap 16, and a second end cap 18. Electric machine 1 includes a rotor assembly 24, a stator assembly 26 including stator end turns 28, bearings 30, and an output shaft 32 secured as part of rotor 24. Rotor 24 rotates within stator 26. Rotor assembly 24 includes a lamination stack 9 formed by stacking, aligning, and securing individual steel laminations that are coated with an electrical insulation. Lamination stack 9 has a columnar inner bore defined by a surface 7. A rotor hub 33 has a cylindrical outer surface 8 structured for engagement with lamination stack inner surface 7. Lamination stack 9 is secured to rotor hub 33 by engagement of surfaces 7, 8 and by one or more keyed and/or meshing structures (not shown). As a result, concentric surfaces 7, 8 form a substantially cylindrical interface 11. Hub 33 has a cylindrical inner bore 10 that is secured to shaft 32 by an interference fit and by a keying structure.

In some embodiments, module housing 12 may include at least one coolant jacket 42, for example including passages within housing body 14 and stator 26. In various embodiments, coolant jacket 42 substantially circumscribes portions of stator assembly 26, including stator end turns 28. A suitable coolant may include transmission fluid, ethylene glycol, an ethylene glycol/water mixture, water, oil, motor oil, a gas, a mist, any combination thereof, or another substance. A cooling system may include nozzles (not shown) or the like for directing a coolant onto end turns 28. The outside surface 15 of stator 26 may be formed to snugly fit in abutment with the radially inner surface 17 of cooling jacket 42 or other housing surface, such as an interior surface of a housing formed without a cooling jacket. Housing 12 may include a plurality of coolant jacket apertures 46 so that coolant jacket 42 is in fluid communication with machine cavity 22. Coolant apertures 46 may be positioned substantially adjacent to stator end turns 28 for the directing of coolant to directly contact and thereby cool end turns 28. For example, coolant jacket apertures 46 may be positioned through portions of an inner wall 48 of body 14. After exiting coolant jacket apertures 46, the coolant flows through portions of machine cavity 22 for cooling other components. In particular, coolant may be directed or sprayed onto hub 33 for cooling of rotor assembly 24. The coolant may be pressurized when it enters the housing 12. After leaving housing 12, the coolant may flow toward a heat transfer element (not shown) outside of the housing 12, for removing the heat energy received by the coolant. The heat transfer element can be a radiator or a similar heat exchanger device capable of removing heat energy.

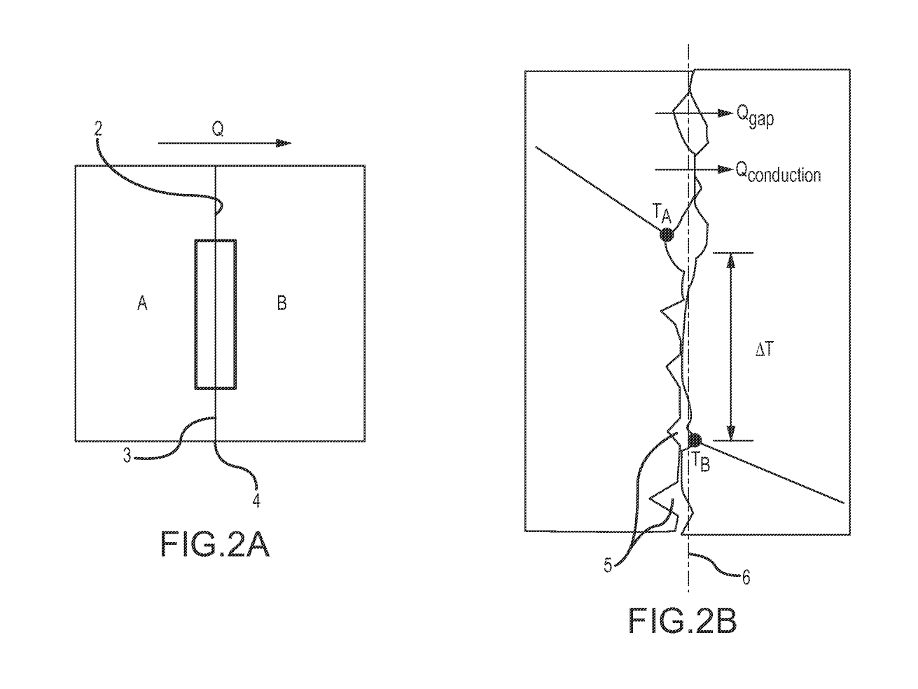

FIG. 2A is a schematic view of two contacting surfaces and FIG. 2B is a schematic view of a portion thereof. When respective complementary mating surfaces 2, 3 of two objects, A and B, are brought into abutment, a quantity of heat Q is transferred by conduction across a heat transfer interface 4. Due to machining limitations, no two solid surfaces ever form a perfect contact when they are pressed together. By comparison with an ideal mating interface, shown in FIG. 2B as a straight line 6, the actual surfaces only approximate being planar and smooth. Tiny air gaps 5 always exist between the two contacting surfaces 2, 3 due to their roughness. Such air gaps 5 create thermal resistance, also referred to as contact resistance, which can create a significant temperature difference between two mating surfaces. In the illustrated example, when heat transfer interface 4 is rough, a temperature T_{A} of object A and a temperature T_{B} of object B do not easily equalize because heat transfer Q_{GAP} across air gaps 5 is limited compared with heat transfer Q_{CONDUCTION} through contiguous surfaces. As a result of the air gaps, a temperature difference ΔT is maintained along portions of heat transfer interface 4 that are missing conduction paths. This same principle applies, for example, to the contiguous interfaces between radially inner surface 7 of lamination stack 9 and radially outward surface 8 of hub 33 (FIG. 1). This contact resistance reduces the thermal efficiency of heat transfer from rotor core 9 into hub 33.

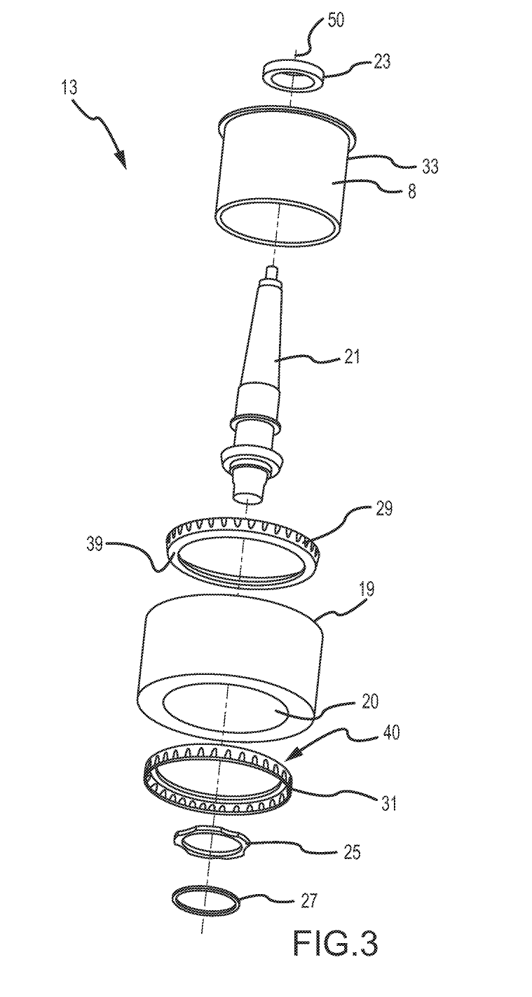

FIG. 3 is an exploded perspective view of a rotor assembly 13 having a center axis 50, according to an exemplary embodiment. A rotor core 19 is formed by stacking individual steel laminations, each coated with an electrical insulation material. The inside surface 20 of rotor core 19 has an interference fit with the outside surface 8 of hub 33. In addition, rotor core 19 and hub 33 typically have a keyed engagement structure to prevent relative circumferential movement and thereby maintain alignment of components. Hub 33 may be secured to a shaft 21 by interference fit, keyed structure, set screw, and/or by fastener(s) (not shown). Hub 33 may be a unitary structure, for example cast steel, or it may be formed as an assembly, for example a lamination stack. Rotor assembly 13 typically also includes one or more bearing assemblies 23, wave washer(s) 25, and spacer(s) 27. A first annular heat sink 29 and a second annular heat sink 31 are respectively secured to opposite axial ends of hub 33. For example, the opposite axial end portions of radially inward surfaces of hub 33 may have a radial press fit against the respective outside diameter(s) of heat sinks 29, 31. The radial press fitting of heat sinks 29, 31 may also be performed so that the respective axially inward surfaces 39, 40 of heat sinks 29, 31 are in abutment with the axial ends of hub 33. Heat sinks 29, 31 may be used for balancing rotor 13 and/or for agitating air or other fluids present in cavity 22 (FIG. 1) by rotary movement of cooling fins extending axially from heat sinks 29, 31. Otherwise, heat sinks 29, 31 act to dissipate excess heat occurring in transient peaks during operation of electric machine 1.

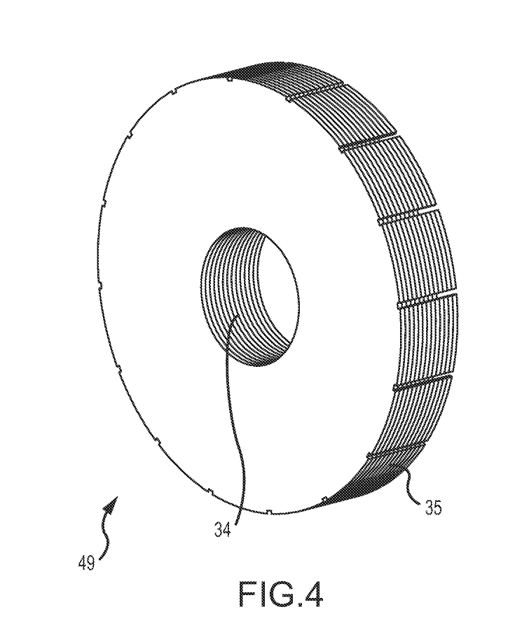

FIG. 4 is a perspective view of an exemplary rotor core 49 formed as a stack of steel laminations. Improvements in stamping and alignment processes reduce but do not eliminate surface roughness for a columnar or cylindrical inner rotor core surface 34 and a cylindrical outer rotor core surface 35. Machining may be used for smoothing inner surface 34 and/or outer surface 35. However, machining may cause electrical shorting of laminations and damage to or removal of insulation coating. In addition, machining adds cost and manufacturing time. Even if machining can be performed to smooth rotor core inner surface 34 without causing structural or electrical damage, the mating of surface 34 with the radially outer surface 8 of a hub 33 will typically still include air gaps 5 (e.g., FIG. 2B) at the interface 4 thereof.

The interface 11 (FIG. 1) between rotor core inner surface 7 and hub outer surface 8 has a high thermal resistance due to surface irregularities and roughness that create air gaps and due to factors such as missing or incomplete attachment or mating structure, mechanical tolerances, inconsistent material properties, and differences in thermal expansion between surfaces, and/or others. It is possible to reduce some of these factors that cause inconsistencies and thermal resistance at interface 11, but remedial steps and processes that include handling may create additional air gaps, for example by causing abrasion. As noted hereinabove, no two solid surfaces ever form a perfect contact when they are pressed together, so the air gaps along interface 11 may be reduced but not eliminated by mechanical processes.

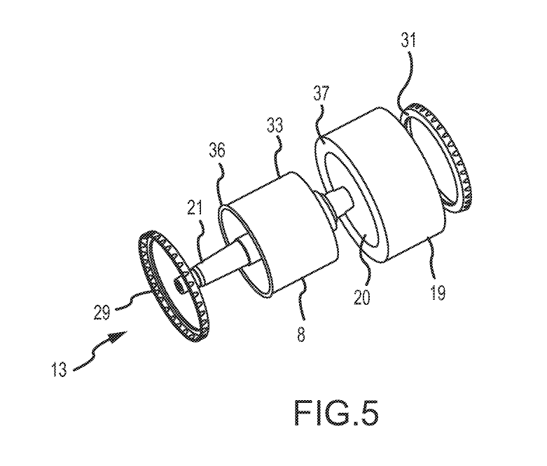

FIG. 5 is a partially exploded view of rotor assembly 13. In an exemplary manufacture, rotor core 19 is heated to approximately 235° F. A thermal interfacial material (TIM) having a high thermal conductivity and having a coefficient of thermal expansion (CTE) approximating that of surfaces 8, 20 is applied to outer hub surface 8. For example, the TIM may be a liquid having a paste-like consistency, a thermal conductivity of 1 to 20 W/m·K, a thickness of 0.002 to 0.5 mm, and a maximum temperature rating of 200° C. The TIM may be used without a hardener and associated curing, or a hardener may be mixed with the TIM before applying it to surface 8. The viscosity of the TIM may be adjusted to optimize flow and removal of air during assembly. The maximum temperature rating of the TIM may be increased to over 350° C., but curing of such material may be difficult and/or impractical. After coating surface 8 with TIM, hub 33 is inserted into the heated rotor core 19. A circumferential rim 36 at an axial end of hub 33 may be formed to abut axial end surface 37 of rotor core 19 when hub 33 has been fully inserted into rotor core 19, or rim 36 may be used as an engagement surface for the inserting of hub 33 into rotor core 19 by a press. Subsequent processing may include cooling the assembly to strengthen the press fit, removing excess TIM that has been squeezed out of the interface, at least partially curing the TIM, applying sealant as described below, balancing, and other processing. In a typical application, the TIM is electrically non-conductive to reduce potential electrical shorting of laminations.

When rotor core 49 is a lamination stack (FIG. 4), a TIM having a lower viscosity may also be applied between individual laminations. For example, low viscosity TIM may be injected by capillary action. In an exemplary embodiment, a low viscosity TIM that is not electrically conductive is wicked into intra-lamination spaces when rotor core 49 is bathed in the TIM prior to assembly; a higher viscosity TIM, for example having a consistency of paste, is then applied to surface 34 of rotor core 49 prior to the insertion of hub 53. As a result, air gaps within rotor core 49 and air gaps at interface 41 are removed. By reducing the thermal resistance within rotor core 49 and at thermal interface 41, additional heat can be dissipated from a rotor assembly, and electric machine 1 can operate at a cooler temperature.

In an alternative embodiment, a “hubless” rotor may be formed by providing a shaft 21 and a rotor core 49 structured for mating with one another. In such a case, rotor core inner surface 34 typically has approximately the same diameter as the outside diameter of shaft 21 and is secured thereto by an interference fit and by being torsionally interlocked, such as by the use of one or more keys (not shown) and corresponding keying slots. Since the mating of surface 34 with the outer surface of shaft 21 otherwise includes air gaps 5, TIM is applied to the interface between surface 34 and shaft 21 to fill gaps 5 and thereby reduce thermal resistance. All features such as keys, grooves, and slots of shaft 21 and surface 34 are filled with TIM, and any excess TIM is wiped off after mating insertion of shaft 21 into rotor core 49. One or more seals may then be formed at axial ends of the shaft/rotor core interface to prevent migration of uncured TIM, when appropriate.

An electric machine in various embodiments may include TIM placed onto radially outer surface(s) of shaft 21, into an interface between hub cylindrical inner bore 10 and shaft 21, and/or into the interface between hub surface 8 and rotor core surface 34. As used herein, the term “hub member” means ‘at least one of a hub and a shaft’ whereby, for example, TIM applied to a hub member is applied to a hub and/or a shaft. A hub member may have a unitary structure where only one interface exists between hub and rotor core, or a hub member may include any number of individual components that have corresponding complementary interfaces at contiguous surfaces thereof. As used herein, a hub member may include a shaft, a shaft and a hub, or a hub with no shaft. In exemplary embodiments, TIM may be applied between a rotor core and a hub where no shaft is present, TIM may be applied between a rotor core and a hub where a shaft is present but where TIM is not applied between the hub and shaft, TIM may be applied between a rotor core and a hub and also between the hub and a shaft, or TIM may be applied between a rotor core and a shaft where no hub is present.

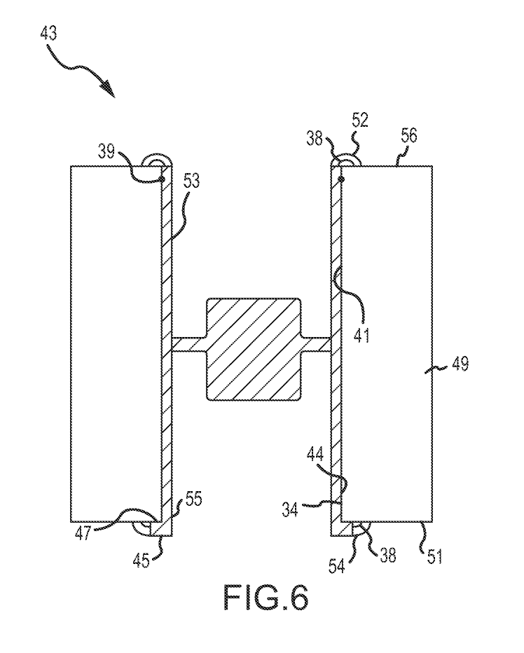

FIG. 6 is a cross-sectional schematic view of a rotor assembly 43 after application of TIM to the interface 41 between hub 53 and rotor core 49, according to an exemplary embodiment. A thin layer of TIM fills air gaps created by surface irregularities, so that substantially all air is removed from interface 41 by being replaced with TIM, thereby greatly reducing thermal resistance at thermal interface 41 and improving thermal transfer between rotor core 49 and hub 53. After assembly, at least one of the annular axial ends of TIM application region 41 may have an annular bead 38 of TIM at the interface of inner rotor surface 34 and hub outer surface 44. Bead 38 results from excess TIM being pushed out of interface 41 or scraped off one or both of surfaces 34, 44. The other axial end of TIM application region 41 may also include an annular bead 38. Sealing the TIM at the circumferential periphery of each axial end of interface 41 may be necessary in applications where the TIM remains in a liquid state and is not cured. Such sealing may prevent migration of air and other contaminants into the TIM spaces, and may prevent displacement of the TIM. Structure of rotor core 49 and/or heat sinks 29, 31 (FIG. 3) may also be adapted to seal TIM within interface 41. In addition, any portion of interface 41 may also contain a sealing member 39, such as an O-ring, a bead of epoxy, a raised portion of rotor core 49 and/or a raised or interlocking portion of hub 53, or other structure. Structure of rim 45 may be adapted to seal TIM application region 41. For example, a portion of axially inward surface 47 may be formed so that a raised portion of rotor core end surface 51 abuts such portion to thereby provide at least a partial seal and a closure of one axial end of region 41. Sealing TIM application region 41 may create a vacuum therein, whereby migration of TIM or air is prevented. When annular beads 38 are fully cured, additional processing may be avoided. However, when the TIM does not fully cure, or when reliability may be affected by centrifugal forces pushing the TIM radially outward over time, any excess TIM in beads 38 is removed and a curable epoxy or the like may then be applied as annular beads 52, 54 for sealing the TIM inside thermal interface 41.

Annular sealing members 52, 54 may be required when migration of TIM is foreseen, for example when viscosity of the TIM is low and/or when TIM at a radially outer edge may be subjected to contaminants. In some applications, such sealing may be effected by use of a temporary gasket that is only required during the manufacturing process. Seals 52, 54 may alternatively include O-rings, gaskets, resin, fiber, and/or structural barriers that block any exit paths out of TIM application region 41. When hub 53 has a rim 45, heat sink 29 may be press fit against the radially inward surface 55 of hub 53 and may be modified to abut rotor core axial end surface 51 while also providing adequate space for rim 45. Heat sink 29 may thereby be axially pressed against hub surface 55 while TIM bead 38 and/or sealant 54 are still in a liquid state, so that heat sink 29 becomes bonded to TIM bead 38 and/or sealant 54. Alternatively, heat sink 29 may be axially pressed against hub surface 55 and TIM bead 38, and an epoxy or other sealant 54 may be subsequently applied to seal any joints between rim 45, heat sink 29, hub 53, and rotor core end surface 51, thereby preventing any migration or contamination of the TIM. Similarly, heat sink 31 may be placed against rotor core end surface 56 and TIM bead 38, and an epoxy or other sealant 52 may then be used to seal any joints between hub 53 and end surface 56. In another exemplary embodiment, the TIM may be placed into interface 41 and also onto rotor core end surfaces 51, 56 so that when heat sinks 29, 31 are respectively placed onto hub end surfaces, heat sinks 29, 31 are thermally interfaced with rotor core 49 and/or hub 53. In such a case, the TIM may be continuous along surfaces 51, 34, 56, or the TIM in interface 41 may only be present for filling air gaps therewithin.

TIM may be partially or fully cured by being mixed with a hardener. Typically such curing takes approximately two hours at room temperature and approximately five minutes at an elevated temperature such as 100° C. Alternatively, TIM may remain in a liquid state when annular sealing members 52, 54 seal TIM application region 41 with separate materials such as beads of epoxy. Further, when TIM is squeezed so that one or both of annular sealing members 52, 54 includes a TIM bead, this exposed TIM may harden and effect a seal. In some applications, TIM maintains a consistency of grease and does not cure. For example, air gaps 5 that exist as a part of imperfections of surfaces 34, 44 may be isolated, and TIM displacing the air of such spaces may therefore also be isolated. Curing and an associated use of hardeners may thereby be unnecessary and/or undesirable.

When TIM has a high viscosity and no migration, the absence of thermal epoxies or other hardeners may reduce shrinkage and similar reliability issues. Depending on a particular application, TIM may contain silicone, alumina or other metal oxides, binding agents, epoxy, and/or other material. TIM has a high thermal conductivity and a high thermal stability, and may be formulated to have minimal evaporation, hardening, melting, separation, migration, or loss of adhesion. Suitable materials are available from TIMTRONICS. However, due to the small size and space of air gaps 5, the size and shapes of fillers and other ingredients of TIM, such as alumina, is typically kept below 0.03 mm.

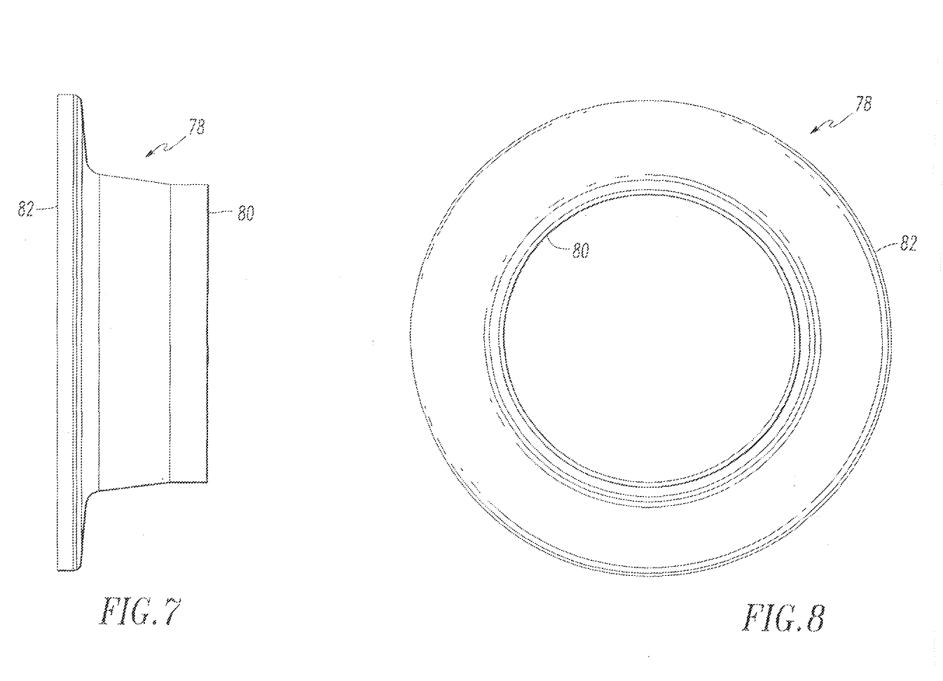

The rate of assembly is typically as slow as is practical. Specifically, when hub 33, 53 is being inserted, a slow insertion movement helps distribute TIM into air gaps 5. The high conformability of TIM assures that nearly all air is removed. A longer cure time assures that TIM spreads and becomes uniformly distributed. For example, a nominal TIM thickness may be 0.03 mm. By slowly lowering the heated housing in an axial direction onto the TIM-coated stator, the interference fitting process removes air gaps 5 by slowly squeezing TIM. Once air gaps 5 have been filled, TIM does not readily migrate because air gaps 5 are not continuous. In other words, the tight fitment at interface 41 and the lack of channels for TIM migration prevent TIM from being displaced prior to curing. In manufacturing, TIM is metered to assure that a precise volume is being applied, whereby residue is minimized and TIM interface 41 becomes uniformly filled. In an alternative manufacture, TIM may be placed onto outer surface 44 of hub 53 prior to assembly, or both surfaces 34, 44 may be coated prior to assembly. To assure that all air gaps 5 are filled, annular rubber blade(s) or the like may be used for spreading TIM onto one or both of surfaces 34, 44 in any number of passes, prior to assembly. Since it may be desirable for TIM to have adherence properties that resist flow, the coating of surface(s) 34, 44 is typically performed by radially forcing TIM against such surface(s). For example, FIGS. 7 and 8 show an exemplary TIM applicator 78 formed as a unitary structure made of rubber. The inside surface 80 has a diameter the same or slightly less than the diameter of a surface being coated with TIM, such as the outer surface of a hub 33. Applicator 78 may be grasped at outside diameter 82 and pulled axially over hub 33 to evenly apply TIM and thereby remove trapped air prior to assembly. Subsequent assembly includes insertion of such pre-coated hub 33, 53, for example, into rotor core 9, 19, 49 to further remove trapped air and provide a consistent thermal interface. The securement of hub 33, 53 to rotor core 9, 19, 49 may include one or more radially-extending projections and corresponding radially-extending mating receptacles (not shown) formed on respective surfaces 34, 44 that serve as one or more keys. The keyed structure(s) prevent relative circumferential movement of rotor components. The placement of TIM into interface 41 includes applying TIM to the key and/or key receptacle prior to insertion of hub 33, 53 into rotor core 9, 19, 49. Since a keyed structure creates one or more potential axial pathways for migration of TIM, sealant(s) are typically used at axial ends of such keyed structure.

Installation of heat sinks 29, 31 (FIG. 3) may be performed by press fitting, welding, staking, adhesives, and/or others, but such processing may cause damage or a reduction in thermal efficiency. For example, welding may also maintain or create air gaps, and welding is impractical because it causes, inter alia, electrical shorting, assembly problems, additional manufacturing time and cost, and alignment and balancing issues. For example, heat sinks 29, 31 may act as balancing rings, where individual fins of heat sinks 29, 31 may be bent slightly to correct rotor imbalance. In particular, heat sink fins may be evenly spaced around the outer circumference of respective heat sinks 29, 31, and individual fins may be bent radially inwardly or outwardly to precisely adjust rotational balance. Typically, automated balancing equipment is adapted to mark individual locations that require bending of fins. Alternatively, such automated balancing equipment may perform the bending, or it may deposit or remove material to/from specific locations on heat sinks 29, 31.

Rotor assembly 41 may be contained in a housing 12 (FIG. 1) having a cavity 22 that contains a volume of air and a circulating coolant such as oil. The rotation of rotor assembly 41 causes the respective annular arrays of fins of heat sinks 29, 31 to create interruption zones in the coolant flow by their circumferential movement. The rotation of the fins also stirs and agitates the air within cavity 22. The movements of coolant and air act to transfer and dissipate heat caused by transient conditions.

Testing of exemplary embodiments has shown a significant improvement in transferring heat from a rotor core to a hub by placement of TIM at the interface therebetween. Coolant may be sprayed onto hub 33, 53 by nozzles (not shown) or by flow of the coolant through cavity 22 (FIG. 1). Thereby, the heat from rotor core 9, 19, 49 is efficiently transferred through thermal interface 11, 41 to hub 33, 53 to the coolant.

Although exemplary embodiments are described for an annular heat transfer interface between surfaces of a hub and a rotor core, the inner surface 34 of rotor core 49 may have any appropriate shape. For example rotor core 49 may be formed of individual core segments (not shown) that are connected to one another to thereby have an inner rotor core surface 34 that may include gaps, slots, protrusions, and other deviations from a relatively smooth cylinder. In such a case, large gaps and holes may be filled with a thermally conductive potting material or the like and cured, prior to TIM coating and coupling of the rotor core to a hub. By this process, the irregularities in a segmented rotor core are substantially eliminated prior to placing TIM into the heat transfer interface. Similarly, any continuous grooves, notches, or protrusions along either mating surface should be removed prior to assembly, so that TIM migration is substantially prevented by elimination of potential migration channels. In other words, by eliminating exit passageways, the TIM cannot migrate. When surfaces 34, 44 have an interference fit, TIM only spreads and fills air gaps 5. Although exemplary embodiments have been described for configurations with a rotor inside of a stator, the embodiments may also be adapted for configurations having a rotor radially outward of a stator.

The embodiments described herein may be combined, when appropriate, with aspects of the co-pending applications entitled “ELECTRIC MOTOR STATOR HOUSING INTERFERENCE GAP REDUCING METHOD AND APPARATUS” and “ELECTRIC MOTOR ROTOR THERMAL INTERFACE FOR HUB/SHAFT.”

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A cooling system of an electric machine, comprising:
a hub member;
a rotor core; and
a thermal interfacial material interposed between respective complementary mating surfaces of the hub member and the rotor core for substantially eliminating air gaps therebetween.

2. The cooling system of claim 1, wherein the hub member includes a substantially cylindrical surface with an annular rim at an axial end thereof.

3. The cooling system of claim 1, wherein the hub member includes a hub and a shaft with thermal interfacial material placed therebetween.

4. The cooling system of claim 1, further comprising an annular heat sink secured to an axial end of the hub member, wherein the thermal interfacial material is interposed between the heat sink and the hub member.

5. The cooling system of claim 1, further comprising an annular perimeter seal around at least one axial end of the thermal interfacial material for enclosing the material between the complementary mating surfaces.

6. The cooling system of claim 5, wherein the seal(s) include epoxy.

7. The cooling system of claim 5, wherein the enclosed thermal interfacial material remains in a liquid state.

8. The cooling system of claim 1, wherein the complementary mating surfaces have an interference fit.

9. The cooling system of claim 1, wherein the thermal interfacial material is substantially uncurable thermal grease.

10. The cooling system of claim 1, wherein the thermal interfacial material has a nominal thickness between 0.002 mm and 0.5 mm.

11. The cooling system of claim 1, wherein the hub member comprises a unitary shaft.

12. A method of cooling an electric machine having a rotor core and a hub member, comprising placing a thermal interfacial material onto a heat transfer interface between the rotor core and the hub member, whereby the thermal interfacial material reduces contact resistance at the heat transfer interface.

13. The method of claim 12, further comprising:
heating and thereby expanding the rotor core;
cooling and thereby shrinking the hub member;
installing the cooled hub member within the heated rotor core; and
cooling the rotor core so that the hub member is interference fit therein.

14. A method of cooling a stator of an electric machine, comprising:
providing a rotor core having a radially inner surface;
coating at least one of a radially outer surface of a hub member and the radially inner surface of the rotor core with a thermal interfacial material; and
inserting the hub member into the rotor core;
whereby the thermal interfacial material is interposed between the inner surface of the rotor core and the outer surface of the hub member.

15. The method of claim 14, further comprising sealing the rotor core to the hub member, thereby enclosing axial ends of the thermal interfacial material.

16. The method of claim 15, wherein the sealing comprises curing the thermal interfacial material.

17. The method of claim 15, wherein the sealing comprises applying a bead of epoxy.

18. The method of claim 15, wherein the sealing comprises extending the thermal interfacial material to an axial end surface of the rotor core and covering the extended thermal interfacial material with a radially-extending portion of a structure coupled to the same axial end of the rotor core.

19. The method of claim 14, further comprising machining the outer surface of the hub member to thereby substantially remove surface irregularities.

20. The method of claim 14, wherein the coating includes radially biasing the thermal interfacial material against the surface being coated.
